(19) United States
(12) Patent Application Publication
(10) Pub. No.: US 2012/0267002 A1
(43) Pub. Date: Oct. 25, 2012

(54) METHOD FOR THE OPERATION AND CONTROL OF GAS FILLING

(75) Inventors: Pål Kittilsen, Trondheim (NO); Pål Midtbøen, Langesund (NO); Kjetil Fjalestad, Skien (NO)

(73) Assignee: NEL HYDROGEN AS, Notodden (NO)

(21) Appl. No.: 13/503,018

(22) PCT Filed: Oct. 21, 2010
(86) PCT No.: PCT/NO2010/000375

§ 371 Date: Jun. 29, 2012

(30) Foreign Application Priority Data
Oct. 21, 2009 (NO) 2009 3181

(51) Int. Cl. F17C 5/00

(52) U.S. Cl. 141/4

(57) ABSTRACT

A method for the operation and control of gas filling from a filling station to a receiver is comprising actively controlling essential filling variables within the receiver such as temperature, pressure, and density of the gas; continuously updating estimates of the filling variables based on filling station side measurements interpreted using physical and thermodynamic relations as to make the variables available even when the receiver is not communicating with the filling station in so-called non-communication fueling; and continuously updating the estimated capacity of the receiver based on station side measurements in a non-communication fueling.

The present invention relates to a method for a safe, accurate and fast operation and control of gas filling, e.g. hydrogen, from a filling station to a receiver such as a vehicle.

Several filling station vendors and research institutes have alternative filling methods, such as referred to in the next section. They most often use correlations from experimental data to generate pre-defined sequences of operation based on parameters like ambient temperature, initial vehicle pressure and cooling capacity on the station.
SAE (2009), Fueling Protocols for Gaseous Hydrogen Surface Vehicles. Working draft to be followed by standard SAE J2601,
U.S. Pat. No. 7,059,364 and references cited therein. GTI's method for hydrogen filling.
WO 2008/110240. Linde's method for rate controlled filling
WO 2007/077376. Air Liquide's method for pressure corridor filling.
U.S. Pat. No. 7,178,565. Air Products' mobile refueller.
Pregassame, S., Barth, F., Allidieres, L., & Barral, K. (2006). Hydrogen refueling station: filling control protocols development. WHEC proceedings. Lyon.
Pregassame, S., Michel, F., Allidieres, L., Bourgeois, P., & Barral, K. (2006). Evaluation of cold filling processes for 70 MPa storage systems in vehicles. WHEC proceedings. Lyon, France.

Limitations/problems with existing technology
Methods with pre-determined, experimental based operation require extensive experimental programs to cover all possible operating conditions. If used outside the covered region, the methods are not reliable.
The methods halt the filling procedure to take necessary measures. Essential parameters are updated discrete and infrequently
There is no online estimate of the vehicle temperature and density, so these quantities cannot be used in online control or optimization, e.g. using an optimized mass flow rate to minimize the filling time.
Mass flow metering is an essential measure in the existing technologies which is not integrated in most of the existing filling algorithms.

However, as all of these previously known solutions are presenting different kind of disadvantages and shortcomings, the main objective of the present invention is to propose a method for the operation and control of hydrogen filling to ensure safe, fast and accurate filling of the tank volume in vehicles, for instance. The method is based on physical and thermodynamically derived relations that give a broad and reliable operational window.

According to the present invention it is provided a method for the operation and control of gas filling from a filling station to a receiver, comprising:
actively controlling essential filling variables within the receiver such as temperature, pressure, and density of the gas;
continuously updating estimates of the filling variables based on filling station side measurements interpreted using physical and thermodynamic relations as to make the variables available even when the receiver is not communicating with the filling station in so-called non-communication fueling; and
continuously updating the estimated capacity of the receiver based on station side measurements in a non-communication fueling.

The main filling can comprise:
if the capacity, temperature, and pressure are continuously communicated in so-called communication fueling, and
if significant deviations between estimated and communicated variables,
using the estimates of these properties and variables to verify the measured and transmitted information, and switching the filling to a safe non-communication fueling mode, respectively.

In a preferred embodiment the filling is further comprising:
utilizing an initial filling sequence for measuring the initial condition of the receiver, e.g. by filling a small amount of gas;
utilizing a main filling sequence by means of a main fill controller operating the process through several function blocks, the main filling sequence is comprising:
   continuously measuring station side temperature and pressure and in a communication fuelling, continuously receiving the receivers temperature and pressure,
   continuously estimating receivers tank capacity, pressure, temperature and density based on station side measurements,
   continuously measuring or estimating gas mass flow rate and accumulated gas mass filled,
   supplying gas by means of a gas supply block that operates the filling station storage and ensures gas flow from storage to the receiver,
   utilizing a communication block as to give relevant information to the operator of the filling station and to the operator of the receiver,
   independently monitoring the progress of the filling as to interrupt the main filling if abnormalities are detected, including comparison of estimated and measured receiver filling variables; and
using an end of filling sequence as to shut down the filling sequence and prepare for the receiver to disconnect from the station.

Further, the estimation of filling variables can comprise:
a physically and thermodynamically based model as to relate the filling station measures such as station storage and line pressures, ambient and line temperatures to the evolution of the pressure and temperature in the receivers gas tank, the model being adapted with empirical or semi-empirical relations to ensure alignment with reality and calculated in real-time using measurements as input.

Preferably, the initial filling can comprise:
opening by means of the first filled amount, check valves in the filling line as to enable measuring of the tank initial pressure and check for leakages and initial conditions are within specified limits to allow filling progress; and
using an optional second, well defined fill, e.g. by filling from a well defined enclosed volume at the filling station, as to give a first accurate estimate of the tank volume/capacity by interpreting the resulting pressure increase therein.

Alternatively, the main filling can comprise:
controlling the rate of gas filled to the receiver by means of a control valve, parallel selectable restrictions, shutting filling on/off or the like,
optionally applying a mass balance to the filling station storage as to measure the mass flow,
a closed loop control of the receiver's gas temperature by manipulating the filling rate and using the measure or estimate of the gas temperature as feedback ensuring the fastest possible filling,
if process data is redundant, executing date reconciliations such as estimating flow both from measuring the pressure drop over a restriction, from a mass balance on storage tanks, from a mass flow meter, and from a mass balance on the receiver, and
cooling, and possibly controlling the temperature of the delivered gas by means of a heat exchanger or the like in the filling line.

Thus, the present invention solves the problems associated with existing technology:
By using physical based relations to calculate essential filling control parameters like vehicle gas density and temperature, the need for experimental data is reduced and the operational envelope expanded.
The method opens the possibility to do all calculations continuously, such that at all times, the most updated and reliable estimates of the essential filling parameters are used. The filling can be operated continuously—there is no need to halt the progress to access measurements for the calculation of filling parameters.
The receiver's temperature becomes available for control using the estimated temperature for feedback and mass flow rate as a manipulated variable. This has not been possible with other non-communication methods. By controlling the temperature, a minimal filling time can be ensured without exceeding safe limits.

Mass flow metering can be done by a mass balance, utilizing simple, reliable instrumentation such as temperature and pressure sensors, thus increasing reliability and reducing investment cost.

Now, the structure of the method according to the present invention is illustrated be means of a preferred embodiment presented the accompanying drawing, in which:

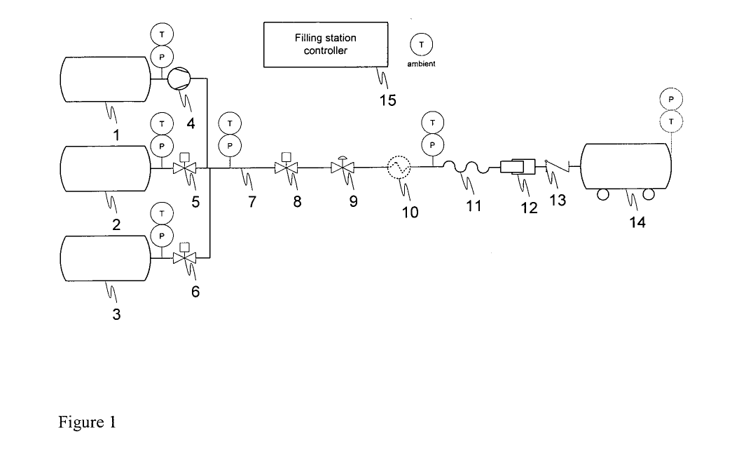

FIG. 1 shows schematically a conceptual filling station with receiving unit attached; and

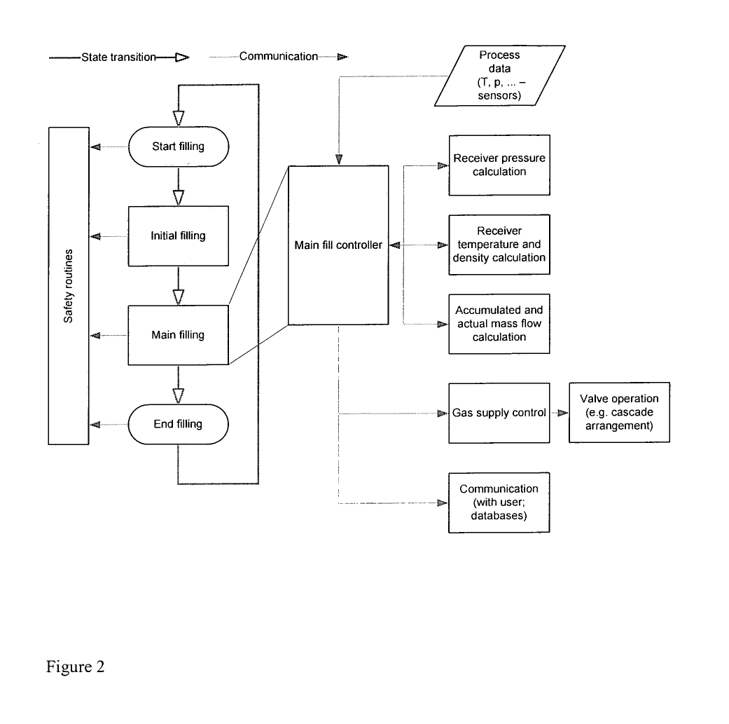

FIG. 2 shows schematically conceptual algorithm steps and communication paths.

As stated above the invention is applicable in different technical fields but is hereinafter discussed by means of an embodiment with reference to vehicles.

The current method is developed for filling with or without communication with the receiver, so-called “communication fueling” (when specified information is transmitted, e.g. IR, from the receiver and verified at the station) and “non-communication fueling” (absence of receiver communication) mode, respectively.

The default mode of operation provides for communication fueling, in which the measured values of the receiver's storage pressure and temperature are utilized for controlling the filling. The fueling station controller switches to non-communication fueling in the event of break in communications. Also if there are significant deviations between the estimated parameters in the present method described hereby, and those measured and communicated from the receiver, a conservative approach should be taken or the filling should be shut down.

The following explains how to make available continuous estimates of the essential filling variables and parameters to be used in non-communication fueling.

It is essential to estimate the receiver's gas pressure during filling for enabling of continuous updates of the receiver's estimated capacity and gas temperature during filling. The following algorithm is enabling a continuous estimate of the vehicle pressure during periods of filling and periods of rest. Some alternative modes of estimation occur:
1. Main filling valve closed. No estimate of receiver's pressure available.
2. Main filling valve open and all tank valves closed. Receiver's pressure equals line pressure.
3. Main filing valve open and one of the tank valves open. Receiver's pressure estimated from the relation derived in this section with upstream pressure equal to the open tank pressure.

Some restrictions apply to the estimated pressure:
Pressure shall always be equal or lower than the line pressure
Pressure shall be larger than a given factor (0-1) of the line pressure. Initially this factor is 0.5.

From the station storage tank to the receiving tank, one can imagine there are two main restrictions to flow: one control or fixed-restriction valve and one internal-receiver restriction. The internal-receiver restriction is considered as a fixed-restriction. During filling, mass flows through both these restrictions with negligible accumulation, and thus the rates through the two restrictions are the same, and one can eliminate the mass flow from the equations and get an estimate of the receiver's pressure.

According to the International standard, IEC 60534-2-1, “Industrial-process control valves—Part 2-1: Flow-capacity—Sizing equations for fluid flow under installed conditions”, the IEC valve equation is as follows:

$$\begin{matrix}W = {NC}_{v} Y \sqrt{{xp}_{1} {ρ}_{1}} & ( 1 ) \\ Y = 1 - \frac{min ( x , {x}_{T} )}{3 {F}_{k} {x}_{T}} \\ x = \frac{{p}_{1} - {p}_{2}}{{p}_{1}} & ( 2 )\end{matrix}$$

Where N and Cᵥ are constants. Substituting the density with proportionality to pressure and compressibility ration (ρ₁∝p₁/z₁), this expression is simplified to:

$$W = k \sqrt{{Y}^{2} \frac{{p}_{1}}{{z}_{1}} ( {p}_{1} - {p}_{2} )} \qquad ( 3 )$$

Indexing the storage pressure with 1, the line pressure with 2 and the receivers' pressure with 3, the equations for the mass flows through the two restrictions are as follows:

$$\begin{matrix}{W}_{1} = {k}_{1} \sqrt{{Y}_{1}^{2} \frac{{p}_{1}}{{z}_{1}} ( {p}_{1} - {p}_{2} )} & ( 4 ) \\ {W}_{2} = {k}_{2} \sqrt{\frac{{p}_{2}}{{z}_{2}} ( {p}_{2} - {p}_{3} )} & ( 5 )\end{matrix}$$

In the last equation above, the expansion factor Y₂ has been assumed constant and included in the constant k₂. This is valid for small differences in pressure 2 and 3 (and makes the estimate of p₃ below first order in p₃).

By conservation of mass, the two mass flows are equal, and p₃ can be expressed as function of the other pressures:

$$\begin{matrix}{W}_{2} = {W}_{1} \\ {k}_{2}^{2} \frac{{p}_{2}}{{z}_{2}} ( {p}_{2} - {p}_{3} ) = {k}_{1}^{2} {Y}_{1}^{2} \frac{{p}_{1}}{{z}_{1}} ( {p}_{1} - {p}_{2} ) & ( 6 ) \\ {p}_{3} = {p}_{2} - {α}_{PE} {Y}_{1}^{2} \frac{{p}_{1}}{{p}_{2}} \frac{{z}_{2}}{{z}_{1}} ( {p}_{1} - {p}_{2} ) & ( 6 )\end{matrix}$$

Where the pressure estimation parameter α_{PE}(=k₁²/k₂²) is subject to tuning, and shall be a function of valve travel in the case of using a control valve.

When knowing (or estimating) an initial temperature and pressure (state 1) and a current temperature and pressure (state 2) given a known added mass, the capacity (volume) of the receiver can be estimation as follows:

$$\begin{matrix}Δ m = {m}_{2} - {m}_{1} = V ( {ρ}_{2} - {ρ}_{1} ) & ( 7 ) \\ V = \frac{Δ m}{ρ ( {T}_{2} , {p}_{2} ) - ρ ( {T}_{1} , {p}_{1} )} & ( 8 )\end{matrix}$$

The accuracy of the capacity estimate is improved by utilizing the fact that it is a specified and limited number of alternative gas tank sizes on the marked. Thus, only given discrete capacity sizes exist which are alternative solutions to the equation.

The suggested method selects the smallest capacity, being the smallest volume, fitting in the range of a smallest and largest estimate of the volume according to equation (8). The large and small estimate is obtained by calculating a minimum and maximum temperature change in the receiving gas tank as derived in the following section.

As an option, an initial estimate of the receiver's capacity can be made by filling a small, well-defined amount of gas, Δm, to the receiver and measuring the resulting change in pressure. This well-defined amount of gas can be the amount contained in a well defined enclosed volume at the filling station, as to give a first accurate estimate of the tank volume/capacity by interpreting the resulting pressure increase therein.

The isothermal and adiabatic temperatures are two extremes between which the actual receiver's gas temperature is ending up.

The case of isothermal filling is the simplest:

T_{2,iso}=T₁ (9)

Where T₁ is the initial gas temperature and T₂ is the temperature at state 2 (intermediate or final).

To derive a case where the temperature changes, it is necessary to set up the enthalpy balance for the receiver's tank:

$$\begin{matrix}Δ H = {n}_{in} {h}_{in} + Vdp + Q \\ Δ ( nh ) = Δ n \cdot {h}_{s} + V Δ p + Q , {h}_{s} = \frac{1}{Δ n} {\int }_{0}^{t} {h}_{s}^{′} ( t ) d n & ( 10 ) \\ {n}_{2} {h}_{2} - {n}_{1} {h}_{1} = ( {n}_{2} - {n}_{1} ) {h}_{s} + V ( {p}_{2} - {p}_{1} ) + Q \\ \frac{{n}_{2}}{V} ( {h}_{2} - {h}_{s} ) - \frac{{n}_{1}}{V} ( {h}_{1} - {h}_{s} ) = {p}_{2} - {p}_{1} + Q & ( 11 )\end{matrix}$$

where hₛ is the (molar/mass) averaged enthalpy of the source (station tank) and index 1 and 2 refer to the initial and final state.

The adiabatic case is when no heat is exchanged with the surroundings, i.e. Q=0. Further, using the state equation pV=znRT, it is possible to eliminate n₁ and n₂:

$$\frac{{p}_{2}}{{z}_{2} {T}_{2}} ( {h}_{2} - {h}_{s} ) - \frac{{p}_{1}}{{z}_{1} {T}_{1}} ( {h}_{1} - {h}_{s} ) = R ( {p}_{2} - {p}_{1} ) \qquad ( 12 )$$

The enthalpy and compressibility factor for state 2 can be approximated by linear expressions:

$${h}_{2} \approx h ( {p}_{2} , {T}_{1} ) + \frac{\partial h}{\partial T} ( {T}_{2} - {T}_{1} ) = {h}_{p 2 , T 1} + {dh}_{p 2 , T 1} ( {T}_{2} - {T}_{1} ) \\ {z}_{2} \approx z ( {p}_{2} , {T}_{1} ) + \frac{\partial z}{\partial T} ( {T}_{2} - {T}_{1} ) = {z}_{p 2 , T 1} + {dz}_{p 2 , T 1} ( {T}_{2} - {T}_{1} ) \qquad ( 13 )$$

The partial derivatives of z and h are found from an equation of state. Inserting these approximations in the enthalpy balance above yields an explicit expression in T₂:

$${T}_{2 , adi} = abs ( abs ( \frac{b}{2 a} ) - \sqrt{{( \frac{b}{2 a} )}^{2} - \frac{c}{a}} ) \\ where \\ a = β {dz}_{p 2 , T 1} , \\ b = β {z}_{p 2 , T 1} - β {dz}_{p 2 , T 1} - {dh}_{p 2 , T 1} , \\ c = - {h}_{p 2 , T 1} + {dh}_{p 2 , T 1} {T}_{1} + {h}_{s} \\ β = R ( 1 - \frac{{p}_{1}}{{p}_{2}} ) + \frac{\frac{{p}_{1}}{{p}_{2}}}{{z}_{1} {T}_{1}} ( {h}_{1} - {h}_{s} ) , \qquad ( 14 )$$

For a direct temperature estimate one can fit an adiabatic factor, α, to relate the real gas temperature to the adiabatic temperature:

T₂=T₁+α(T_{2,adi}−T₁) (15)

Using a band of adiabatic factors results in a band of resulting temperatures:

T_{2,min}=T₁+αₘᵢₙ(T_{2,adi}−T₁)

T_{2,max}=T₁+αₘₐₓ(T_{2,adi}−T₁) (16)

The adiabatic factor is a tuning parameter; generally being dependent on filling rate, tank type etc.

The algorithm for estimating the receiver's capacity in terms of volume is thereby:
1. Calculate Vₘᵢₙ from T_{2,min} and Vₘₐₓ from T_{2,max} using equation (16) and (8).
2. Select the smallest volume in the list of possible volumes Vε[V₁,V₂, . . . , Vₙ] which fulfills Vₘᵢₙ<Vᵢ<Vₘₐₓ.
3. If no entry in the list fulfills the criterion in bullet 2, use the smallest volume estimate, i.e. Vₘᵢₙ

When the tank volume is determined, it is possible to estimate the density from the following equation:

$${ρ}_{2} = ρ ( {T}_{1} , {p}_{1} ) + \frac{Δ m}{V} \qquad ( 17 )$$

The density function can be an equation of state such as the one recommended by NIST, i.e. Lemmon, E. W., Huber, M. L., Fried, D. G., Paulina, C., Standardized equation for hydrogen gas dens ties for fuel consumption applications, SAE 2006-01-0434; http://www.boulder.nist.gov/div838/Hydrogen/PDFs/Hydrogen-2006-01-0434.pdf.

Further, the temperature can be estimated as follows:

$$\begin{matrix}\frac{{p}_{2} {M}_{w}}{{z}_{2} {RT}_{2}} = {ρ}_{1} + \frac{Δ m}{V} & ( 18 ) \\ {T}_{2} = \frac{{p}_{2} {M}_{w}}{{z}_{2} R ( {ρ}_{1} + \frac{Δ m}{V} )} & ( 19 )\end{matrix}$$

The last equation is implicit in T₂ because z₂ is also a function of T₂. Therefore, an iterative loop must be made where z₂ is updated by the previous estimate of T₂. Three iterations are recommended.

Mass flow metering can be done by applying a mass balance to the filling station storage tanks. In this way one utilizing simple, reliable instrumentation such as temperature and pressure sensors, thus increasing reliability and reducing investment cost.

The amount of gas filled from a storage tank is found from a mass balance using the density function. Here index 1 and 2 are for the initial and final states respectively:

m₁=Vρ₁, ρ₁=ρ(T₁,p₁)

m₂=Vρ₂, ρ₂=ρ(T₂,p₂)

Δm=m₁−m₂=V(ρ₁−ρ₂) (20)

The temperatures are preferably measured storage gas temperatures, or estimated from ambient temperature corrected for the temperature loss as a consequence of expansion. For a multi-tank storage, a similar mass balance must be applied to each of the tanks.

The mass flow rate can be found by differentiating the mass balance equation:

$$w = \frac{\partial m}{\partial t} = V ( {ρ}_{1} - \frac{\partial {ρ}_{2}}{\partial t} ) \qquad ( 21 )$$

The structure of the method according to the present invention is illustrated be means of a preferred embodiment presented a single accompanying drawing (FIG. 1,2).

As stated above the invention is applicable in different technical fields but is hereinafter discussed by means of an embodiment with reference to vehicles.

As already mentioned above, FIG. 1 is presenting one example of a conceptual filling station with receiving unit attached.

The station is illustrated with a low pressure tank 1, and two separate high pressure tanks 2, 3 but, when needed, each of these tanks may be supplemented with more tanks or one of the tank types may be omitted. The low pressure tank is provided with a compressor 4 and each of high pressure tanks are having an on/off valve 5, 6. A receiver tank 14 with a check valve 13 is connected to the filling by means of a connector 12. To enable well defined initial measure and check conditions in the receiving tank 14, the filling station is provided with an enclosed volume 7 also communicating with the low and high pressure tanks 1, 2, 3. In extension of enclosed volume a filling on/off valve 8, a filling control valve 9, an optional cooler 10 are arranged in the pipe extending therefrom and is terminating in the connector 12 by means of a flexible hose 11. A filling station controller 15 is connected, not illustrated, to all instrumentation and automatic valves.

As shown in FIG. 2, the exemplary main method blocks and their function are:
A safety block which runs independently of the other blocks and monitors the progress of the filling and interrupts if abnormalities are detected. The main safety checks are:
   initial pressure in vehicle (low and high limit);
   pressure in the filling line (high limit);
   pressure drop rate in the filling line during filling pauses (high limit);
   filling rate change (high limit);
   amount of gas from one storage tank (high limit).
An initial filling block which fills small well defined amounts of gas to the vehicle tank 14 by utilizing the enclosed volume in a pipe segment at the filling station 7. The first filled amount opens check valves in the filling line 13 and enables measuring of the vehicle initial pressure and check for leakages and that the pressure is within an acceptable range for further progress. The optional second well defined fill is done to give a first accurate estimate of the vehicle's capacity (tank volume) by examining the resulting pressure increase in the vehicle. The algorithm progress to the main filling block if the initial filling's checks and estimates allow for progress of the filling.
A main filling block being the master unit operating the process measurements, calling the other function blocks to get estimates of essential filling parameters. This block contains the control algorithm and fills the vehicle tank to its desired density in an optimal manner (fastest possible without violating constraints like temperature limits). Data reconciliation can be done if process data is redundant.
   A gas supply control block which request and control the amount/rate of gas filled to the vehicle.
   A mass flow calculation block to continuously measure the filled amount of hydrogen and the current mass flow rate based on a mass balance on the filling station storage.
   A vehicle pressure calculation block giving a continuous estimate of the vehicle pressure.
   A vehicle temperature and density calculation block which continuously gives updated estimates of the vehicle temperature and pressure based on equations derived from fundamental thermodynamics combined with experimental determined parameters. In addition, a list of available vehicle tank sizes on the marked are used to increase the accuracy of the estimate.
A gas supply control block which request and control the amount/rate of gas filled to the vehicle.

Essential and specific elements in this invention are as follow:

Continuously updated estimates of filling control variable such as vehicle gas volume, gas pressure, gas temperature, and gas density based on fundamental physical and thermodynamic relations.

In a communication-type of filling, these estimates are used to verify the measured and communicated filling variables. In case of deviations, the filling switches to a safe mode.

The accuracy of the estimates is further improved by utilizing the fact that there is a limited alternative possible vehicle tank sizes on the marked. This ensures the best possible reproducibility accuracy with respect to state of charge (SoC) at the end of filling.

The temperature estimate is used online to control of the filling rate, enabling a fast filling. Typically, the temperature is to be controlled to a setpoint and kept there during the filling. This is the optimal filling strategy for the fastest possible filling.

An optional initial filling sequence with two small well controlled filled masses ensures an initial accurate capacity (volume) estimate of the vehicle tank.

Optionally, the method is utilizing mass balance for measuring the mass flow instead of a conventional mass flow meter.

If process data is redundant, the algorithm can execute date reconciliations such as estimating flow both from measuring the pressure drop over a restriction, from a mass balance on storage tanks, from a mass flow meter, and from a mass balance on the receiver.

1. A method for the operation and control of gas filling from a filling station to a receiver, characterized in that the method is comprising:
actively controlling essential filling variables within the receiver, said filling variables including temperature, pressure, and density of the gas;
continuously updating estimates of the filling variables based on filling station side measurements interpreted using physical and thermodynamic relations as to make the variables available even when the receiver is not communicating with the filling station in so-called non-communication fueling; and
continuously updating the capacity of the receiver based on station side measurements in a non-communication fueling.

2. A method according to claim 1, characterized in that the main filling is further comprising:
if the capacity, temperature, and pressure are continuously communicated in so-called communication fueling, using the estimates of these properties and variables to verify the measured and transmitted information.

3. A method according to claim 2, characterized in that the main filling is further comprising:
if significant deviations between estimated and communicated variables, switching the filling to a safe non-communication fueling mode.

4. A method according to claim 1, characterized in that the filling is further comprising:
utilizing an initial filling sequence for measuring the initial condition of the receiver, e.g. by filling a small amount of gas;
utilizing a main filling sequence by means of a main fill controller operating the process through several function blocks, the main filling sequence is comprising:
continuously measuring station side temperature and pressure and in a communication fuelling, continuously receiving the receivers temperature and pressure,
continuously estimating receivers tank capacity, pressure, temperature and density based on station side measurements,
continuously measuring or estimating gas mass flow rate and accumulated gas mass filled,
supplying gas by means of a gas supply block that operates the filling station storage and ensures gas flow from storage to the receiver,
utilizing a communication block as to give relevant information to the operator of the filling station and to the operator of the receiver,
independently monitoring the progress of the filling as to interrupt the main filling if abnormalities are detected, including comparison of estimated and measured receiver filling variables; and
using an end of filling sequence as to shut down the filling sequence and prepare for the receiver to disconnect from the station.

5. A method according to claim 1, characterized in that the estimation of filling variables are further comprising:
a physically and thermodynamically based model as to relate the filling station measures such as station storage and line pressures, ambient and line temperatures to the evolution of the pressure and temperature in the receivers gas tank, the model being adapted with empirical or semi-empirical relations to ensure alignment with reality and calculated in real-time using measurements as input.

6. A method according to claim 1, characterized in that the initial filling is comprising:
opening by means of the first filled amount check valves in the filling line as to enable measuring of the tank volume initial pressure and check for leakages and initial conditions are within specified limits to allow filling progress; and
using an optional second well defined fill, e.g. by filling from a well defined enclosed volume at the filling station, as to give a first accurate estimate of the tank volume/capacity by interpreting the resulting pressure increase therein.

7. A method according to claim 1, characterized in that the main filling is comprising:
controlling the rate of gas filled to the receiver by means of a control valve, parallel selectable restrictions, or shutting filling on/off.

8. A method according to claim 1, characterized in that the main filling is comprising:
optionally applying a mass balance to the filling station storage as to measure the mass flow.

9. A method according to claim 1, characterized in that the main filling is comprising:
a closed loop control of the receiver's gas temperature by manipulating the filling rate and using the measure or estimate of the gas temperature as feedback ensuring the fastest possible filling.

10. A method according to claim 1, characterized in that the main filling is comprising:
if process data is redundant, executing date reconciliations such as estimating flow both from measuring the pressure drop over a restriction, from a mass balance on storage tanks, from a mass flow meter, and from a mass balance on the receiver.

11. A method according to claim 1, characterized in that the main filling is comprising:
cooling and possibly controlling the temperature of the delivered gas by means of a heat exchanger in the filling line.
